(19) United States
(12) Patent Application Publication
(10) Pub. No.: US 2006/0242986 A1
(43) Pub. Date: Nov. 2, 2006

(54) Automatic icemaker

(75) Inventors: Kenji Sugaya, Kiryu-shi (JP); Hideaki Ito, Kiryu-shi (JP)

Correspondence Address: BIRCH STEWART KOLASCH & BIRCH, PO BOX 747, FALLS CHURCH, VA, 22040-0747, US

(73) Assignee: JAPAN SERVO CO., LTD.

(21) Appl. No.: 11/409,959

(22) Filed: Apr. 25, 2006

(30) Foreign Application Priority Data
Apr. 27, 2005 (JP) 2005-129401

(51) Int. Cl. A23G 9/00; F25C 1/00

(52) U.S. Cl. 62/345; 62/353

(57) ABSTRACT

Disclosed is an automatic icemaker comprising a main body, an ice-making tray rotatably fitted to the main body, and a device for rotating the ice-making tray, wherein the ice-making tray is provided with a plurality of small chambers, the plurality of the small chambers are arranged in the direction of a rotation center line of the ice-making tray, and a water channel in a groove shape is provided at respective off-center portions of partition walls, each being provided between the small chambers adjacent to each other, or an upper surface of a partition wall provided between the respective small chambers adjacent to each other is positioned below an upper surface of the ice-making tray.

### BACKGROUND OF THE INVENTION

1. Field of the Invention

The present invention relates to an automatic icemaker capable of carrying out automatic ice making.

2. Description of the Related Art

A conventional automatic icemaker comprises an ice-making tray having a plurality of small chambers, and a water channel in a groove shape is provided between the respective small chambers adjacent to each other in order to evenly distribute water poured from above the ice-making tray into the respective small chambers.

However, with the above-described automatic icemaker in a state where water is fed into the respective small chambers thereof, the water is present in the water channel as well, so that the water in the water channel is also frozen when the water in the respective small chambers is frozen, and consequently, ice pieces formed in the respective small chambers adjacent to each other are joined together through the intermediary of ice pieces formed in the water channel, resulting in difficulty with discharging the ice pieces out of the ice-making tray, and necessitating a user to break up connections of the ice pieces when the user makes use of the ice pieces.

Accordingly, with another conventional automatic icemaker, small chambers of an ice-making tray are disposed in a stepwise manner, and a groove is provided between the respective small chambers adjacent to each other to thereby sequentially feed water to the respective small chambers via the respective grooves by pouring water on the small chamber in the uppermost step.

With the automatic icemaker described as above, since the small chambers are disposed in the stepwise manner, no water is present in the respective grooves even in a state where water is fed into the respective small chambers, so that ice pieces formed in the respective small chambers adjacent to each other are not joined together when the water in the respective small chambers is frozen.

However, since the small chambers of the ice-making tray are disposed in the stepwise manner, a makeup of the icemaker increases in size, and since the water is sequentially fed to the respective small chambers by pouring the water on the small chamber in the uppermost step, water-feed time becomes longer.

### SUMMARY OF THE INVENTION

It is therefore an object of the invention to provide an automatic icemaker capable of preventing ice pieces formed in respective small chambers adjacent to each other from being joined together without causing a makeup thereof to increases in size, and water-feed time to increases in length.

According to one aspect of the present invention, there is provided an automatic icemaker comprising a main body, an ice-making tray rotatably fitted to the main body, and a device for rotating the ice-making tray, wherein the ice-making tray is provided with a plurality of small chambers, the plurality of the small chambers are arranged in the direction of a rotation center line of the ice-making tray, and a water channel in a groove shape is provided at respective off-center portions of partition walls, each being provided between the respective small chambers adjacent to each other.

With this automatic icemaker described as above, when the ice-making tray is caused to be in as-tilted state, water in the respective small chambers can flow through the water channel, so that it is possible to evenly distribute poured water into the respective small chambers. Further, in a state where the ice-making tray is caused to be in the horizontal state, thereby causing a water surface of the water in the respective small chambers to be positioned lower than the bottom face of the water channel, no water remains in the water channel, and consequently, ice pieces formed in the respective small chambers adjacent to each other are not joined together through the intermediary of ice pieces formed in the water channel, so that there results no difficulty with discharging the ice pieces out of the ice-making tray, and a user need not break up connections of the ice pieces when the user makes use of the ice pieces. Further, since the small chambers of the ice-making tray are not disposed in a stepwise manner, a makeup of the icemaker does not increase in size, and since there is no need for sequentially feeding water to the respective small chambers, water-feed time does not become longer.

According to another aspect of the present invention, there is provided an automatic icemaker comprising a main body, an ice-making tray rotatably fitted to the main body, and a device for rotating the ice-making tray, wherein the ice-making tray is provided with a plurality of small chambers, the plurality of the small chambers are arranged in the direction of a rotation center line of the ice-making tray, and an upper surface of a partition wall provided between the respective small chambers adjacent to each other is positioned below an upper surface of the ice-making tray.

With this automatic icemaker described as above, when the ice-making tray is caused to be in as-tilted state, water in the respective small chambers can flow over a portion of an upper surface of each of the partition walls, so that it is possible to evenly distribute poured water into the respective small chambers. Further, in a state where the ice-making tray is caused to be in the horizontal state, if water surfaces of the water in the respective small chambers are caused to be positioned below the respective upper surfaces of the partition walls, ice pieces formed in the respective small chambers adjacent to each other are not joined together, so that there results no difficulty with discharging the ice pieces out of the ice-making tray, and a user need not break up connections of the ice pieces when the user makes use of the ice pieces. Further, since the small chambers of the ice-making tray are not disposed in a stepwise manner, a makeup of the icemaker does not increase in size, and since there is no need for sequentially feeding water to the respective small chambers, water-feed time does not become longer.

### BRIEF DESCRIPTION OF THE DRAWINGS

Other features and advantages of the present invention will become more apparent from the following detailed description when taken in conjunction with the accompanying drawings, wherein:

FIG. 1 is a schematic and partially sectional view showing an embodiment of an automatic icemaker according to the invention;

FIG. 2 is a sectional view taken on line A-A in FIG. 1;

FIG. 3 is an enlarged sectional view taken on line B-B in FIG. 1;

FIGS. 4A to 4E are illustrations showing an operation of the automatic icemaker shown in FIGS. 1 to 3;

FIG. 5 is a partially sectional view showing another embodiment of an automatic icemaker according to the invention;

FIGS. 6A to 6C are illustrations showing an operation of the automatic icemaker shown in FIG. 5;

FIG. 7 is a partially sectional view showing a still another embodiment of an automatic icemaker according to the invention;

FIGS. 8A to 8C are illustrations showing an operation of the automatic icemaker shown in FIG. 7;

FIG. 9 is a partially sectional view showing a further embodiment of an automatic icemaker according to the invention;

FIGS. 10A to 10D are illustrations showing an operation of the automatic icemaker shown in FIG. 9;

FIG. 11 is a partially sectional view showing a still further embodiment of an automatic icemaker according to the invention; and

FIGS. 12A and 12B are illustrations showing an operation of the automatic icemaker shown in FIG. 11.

### DETAILED DESCRIPTION OF PREFERRED EMBODIMENTS

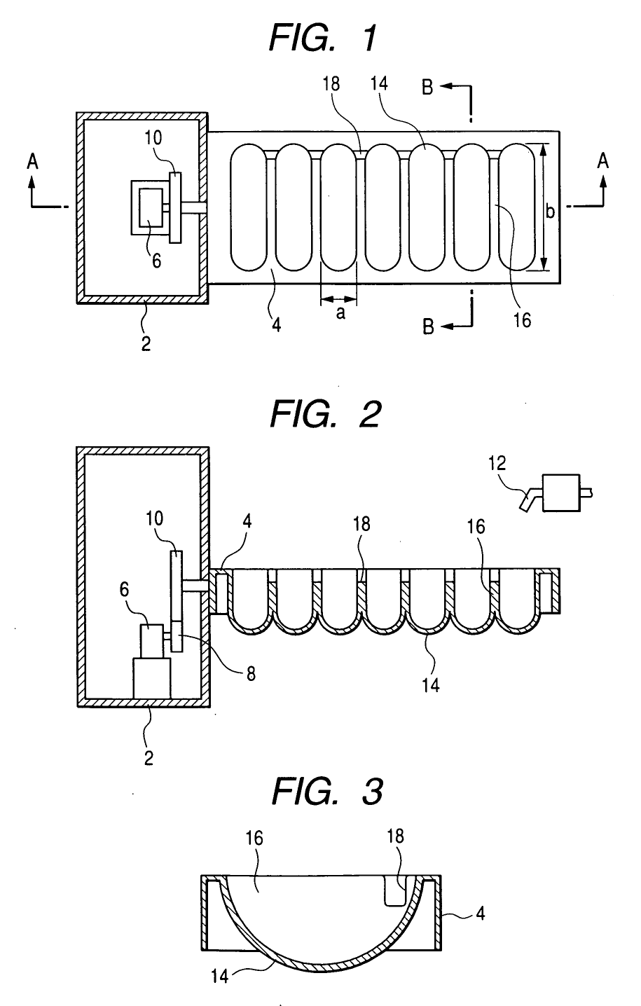

An embodiment of an automatic icemaker according to the invention is described hereinafter with reference to FIGS. 1 to 3. An ice-making tray 4 is rotatably fitted to a main body 2. A reciprocally rotatable motor 6 is provided inside the main body 2. A pinion gear 8 is fitted to an output axle of the motor 6. A driven gear 10 is fitted to an axle of the ice-making tray 4, and the pinion gear 8 is meshed with the driven gear 10. A device for rotating the ice-making tray 4 is made up of the motor 6, the pinion gear 8, and the driven gear 10. A water inlet 12 is provided above the ice-making tray 4. The ice-making tray 4 is provided with a plurality of small chambers 14, and the plurality of the small chambers 14 are arranged in the direction of a rotation center line of the ice-making tray 4. A size “a” of an upper part of the small chamber 14, in the direction of the rotation center line of the ice-making tray 4, is smaller than a size “b” thereof, in the direction orthogonal to the direction of the rotation center line of the ice-making tray 4. A water channel 18 in a groove shape is provided at respective end portions of partition walls 16, each being provided between the respective small chambers 14 adjacent to each other.

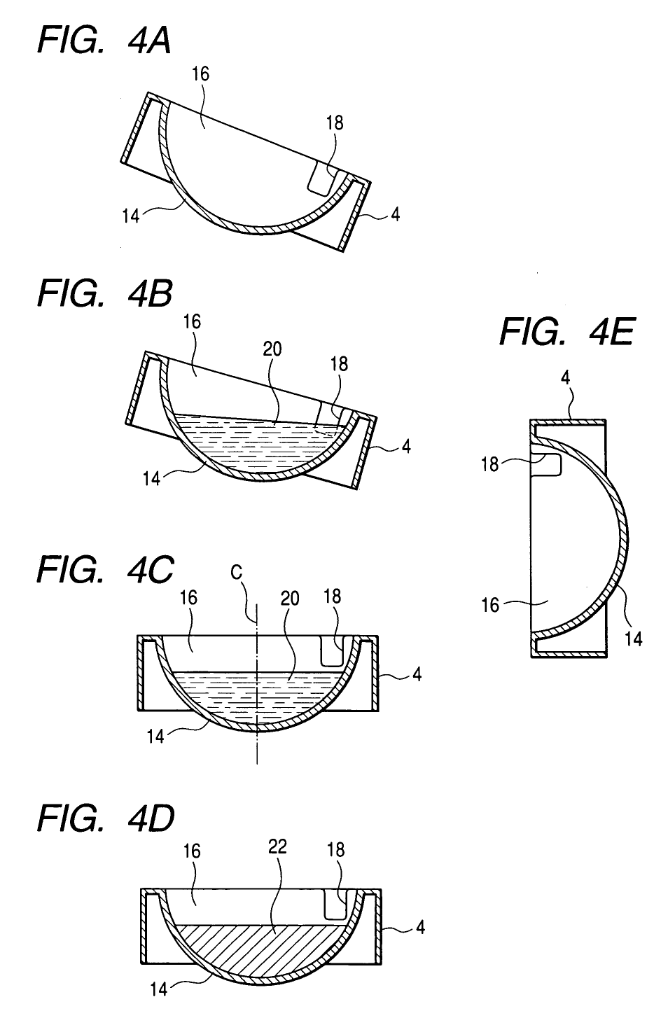

Now, a method of making ice pieces by use of the automatic icemaker described as above is described hereinafter. First, the motor 6 is activated to thereby cause the ice-making tray 4 to be in as-tilted state, as shown in FIG. 4A. Subsequently, water 20 is fed from the water inlet 12 into the small chamber 14, as shown in FIG. 4B. Then, the motor 6 is activated to thereby cause the ice-making tray 4 to be in the horizontal state, as shown in FIG. 4C. In this state, an intersecting line between the center face C of the small chamber 14, and a water surface of the water 20 coincides with the rotation center line of the ice-making tray 4. Subsequently, the water 20 inside the small chamber 14 is frozen to be turned into an ice piece 22, as shown in FIG. 4D. Then, the motor 6 is activated to rotate the ice-making tray 4 by 90 degrees, thereby discharging the ice piece 22 inside the small chamber 14 into an ice-piece-storage box (not shown) disposed below the ice-making tray 4, as shown in FIG. 4E.

With this automatic icemaker described, in a state shown in FIG. 4B, the water 20 in the respective small chambers 14 can flow through the water channel 18, so that it is possible to evenly distribute poured water into the respective small chambers 14. Further, in a state shown in FIG. 4C, since the water surface of the water 20 in the respective small chambers 14 is positioned lower than the bottom face of the water channel 18, no water remains in the water channel 18, and consequently, the ice pieces 22 in the respective small chambers 14 adjacent to each other are not joined together through the intermediary of ice pieces formed in the water channel 18, so that there results no difficulty with discharging the ice pieces 22 out of the ice-making tray 4, and a user need not break up connections of the ice pieces when the user makes use of the ice pieces. Further, since the small chambers 14 of the ice-making tray 4 are not disposed in a stepwise manner, a makeup of the icemaker does not increase in size, and since there is no need for sequentially feeding water to the respective small chambers, water-feed time does not become longer. Further, since the size “a” of the upper part of the small chamber 14, in the direction of the rotation center line of the ice-making tray 4, is smaller than the size “b” thereof, in the direction orthogonal to the direction of the rotation center line of the ice-making tray 4, a distance from the rotation center line of the ice-making tray 4 to a side part of the ice-making tray 4, that is, a turning radius, becomes larger, so that even if a rotation angle of the ice-making tray 4 is small, the water 20 in the respective small chambers 14 can flow through the water channel 18.

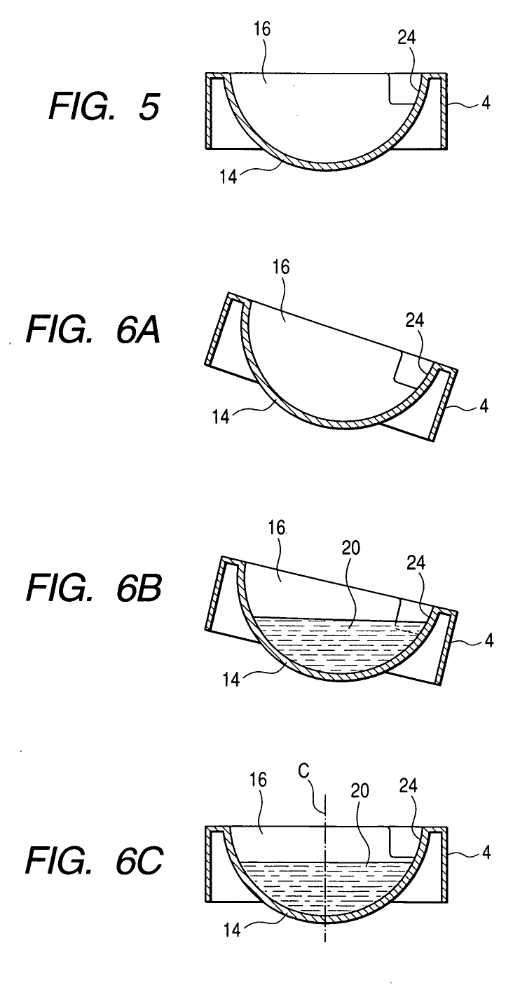

Another embodiment of an automatic icemaker according to the invention is described hereinafter with reference to FIG. 5. A water channel 24 is provided at respective end portions of partition walls 16, each being provided between the respective small chambers 14 adjacent to each other, and the wall of the water channel 24, on one side thereof, is in common with the wall of an ice-making tray 4.

A method of making ice pieces by use of this automatic icemaker described as above is described hereinafter. First, a motor 6 is activated to thereby cause the ice-making tray 4 to be in as-tilted state, as shown in FIG. 6A. Subsequently, water 20 is fed from a water inlet 12 into the small chamber 14, as shown in FIG. 6B. Then, the motor 6 is activated to thereby cause the ice-making tray 4 to be in the horizontal state, as shown in FIG. 6C. In this state, an intersecting line between the center face C of the small chamber 14, and a water surface of the water 20 coincides with a rotation center line of the ice-making tray 4. Subsequently, as with the case of the automatic icemaker shown in FIGS. 1 to 3, the water 20 inside the small chamber 14 is frozen to be thereby turned into an ice piece 22 before discharging the ice piece 22 inside the small chamber 14 into an ice-piece-storage box.

With this automatic icemaker as well, in a state shown in FIG. 6B, the water 20 in the respective small chambers 14 can flow through the water channel 24, so that it is possible to evenly distribute poured water into the respective small chambers 14. Further, in a state shown in FIG. 6C, since a water surface of the water 20 in the respective small chambers 14 is positioned lower than the bottom face of the water channel 24, no water remains in the water channel 24, and consequently, the ice pieces 22 in the respective small chambers adjacent to each other are not joined together through the intermediary of ice pieces formed in the water channel 24. Further, since the small chambers 14 of the ice-making tray 4 are not disposed in a stepwise manner, a makeup of the icemaker does not increase in size, and since there is no need for sequentially feeding water to the respective small chambers, water-feed time does not become longer.

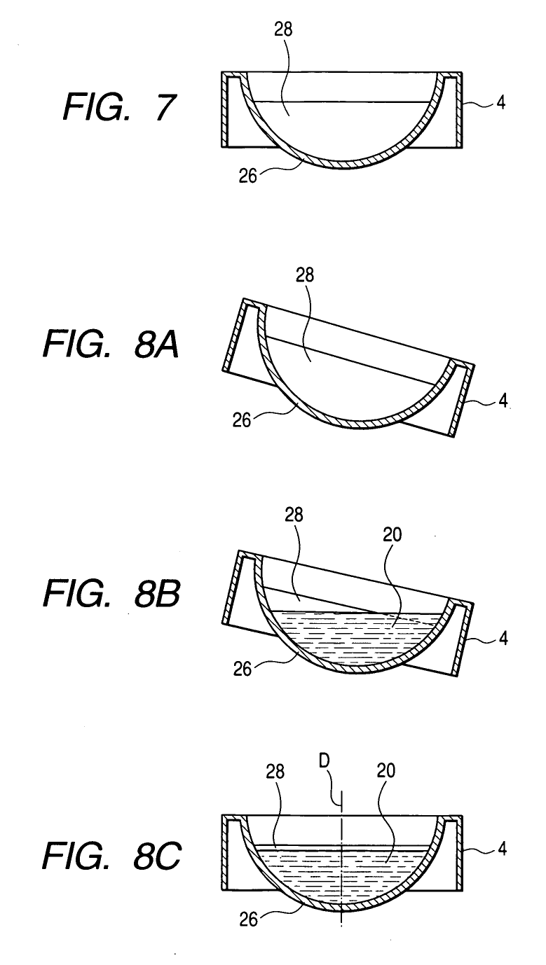

A still another embodiment of an automatic icemaker according to the invention is described hereinafter with reference to FIG. 7. An ice-making tray 4 is provided with a plurality of small chambers 26, and the plurality of the small chambers 26 are arranged in the direction of a rotation center line of the ice-making tray 4. An upper surface of a partition wall 28 between respective small chambers 26 adjacent to each other is positioned below an upper surface of the ice-making tray 4. A size of an upper part of the small chamber 26, in the direction of the rotation center line of the ice-making tray 4, is smaller than a size thereof, in the direction orthogonal to the direction of the rotation center line of the ice-making tray 4.

A method of making ice pieces by use of this automatic icemaker described as above is described hereinafter. First, a motor 6 is activated to thereby cause the ice-making tray 4 to be in as-tilted state, as shown in FIG. 8A. Subsequently, water 20 is fed from a water inlet 12 into the small chamber 26, as shown in FIG. 8B. Then, the motor 6 is activated to thereby cause the ice-making tray 4 to be in the horizontal state, as shown in FIG. 8C. In this state, an intersecting line between the center face D of the small chamber 26, and a water surface of the water 20 coincides with a rotation center line of the ice-making tray 4. Subsequently, as with the case of the automatic icemaker shown in FIGS. 1 to 3, the water 20 inside the small chamber 26 is frozen to be thereby turned into an ice piece 22 before discharging the ice piece 22 inside the small chamber 26 into an ice-piece-storage box.

With this automatic icemaker described as above, in a state shown in FIG. 8B, the water 20 in the respective small chambers 26 can flow over a portion of the upper surface of the partition wall 28, on the right side in the figure, so that it is possible to evenly distribute poured water into the respective small chambers 26. Further, in the state shown in FIG. 8C, the water surfaces of the water 20 in the respective small chambers 26 are positioned below the upper surfaces of the partition walls 28, so that the ice pieces 22 in the respective small chambers 26 adjacent to each other are not joined together. Further, since the small chambers 26 of the ice-making tray 4 are not disposed in a stepwise manner, a makeup of the icemaker does not increase in size, and since there is no need for sequentially feeding water to the respective small chambers, water-feed time does not become longer. Further, since a size of an upper part of the small chamber 26, in the direction of a rotation center line of the ice-making tray 4, is smaller than a size thereof, in the direction orthogonal to the direction of the rotation center line of the ice-making tray 4, a turning radius becomes larger, and even if a rotation angel of the ice-making tray 4 is small, the water 20 in the respective small chambers 26 can flow over the portion of the upper surface of the partition wall 28, on the right side in the figure, so that it is possible to reduce a distance between the upper surface of the partition wall 28 and the upper surface of the ice-making tray 4.

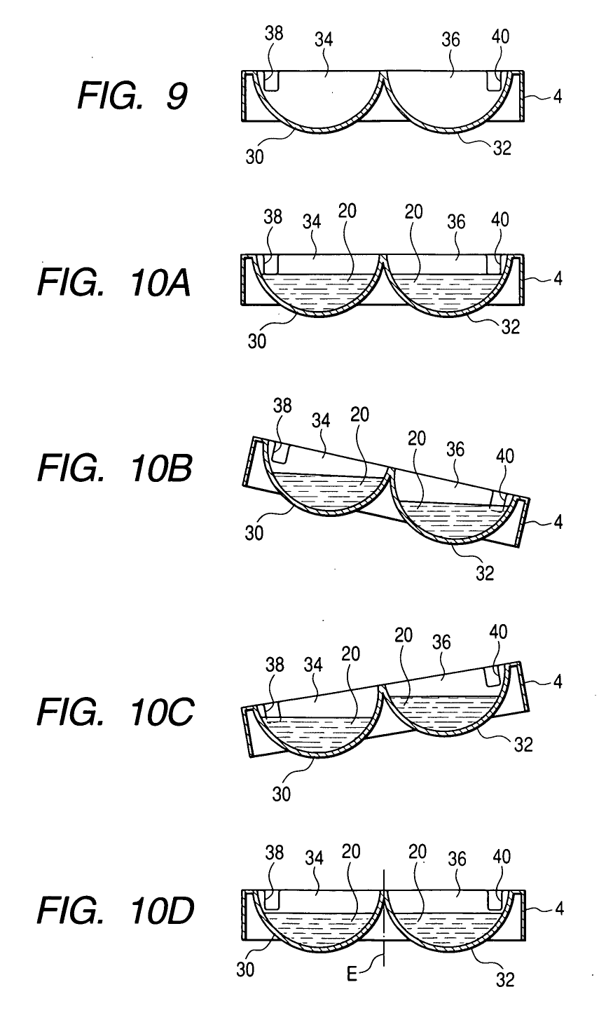

A further embodiment of an automatic icemaker according to the invention is described hereinafter with reference to FIG. 9. An ice-making tray 4 is provided with a plurality of small chambers 30, 32, arranged in two lines, and the plurality of the small chambers 30, 32, in the respective lines, are arranged in the direction of a rotation center line of the ice-making tray 4. Partition walls 34, 36 are provided between the respective small chambers 30, 32, adjacent to each other in the respective lines, and water channels 38, 40 are provided at respective end portions of the partition walls 34, 36, in the direction toward respective outer sides of the ice-making tray 4.

A method of making ice pieces by use of this automatic icemaker described as above is described hereinafter. First, water 20 is fed from two water inlets into the small chambers 30, 32, respectively, with the ice-making tray 4 kept in the horizontal state as shown in FIG. 10A. Next, a motor 6 is activated to thereby cause the ice-making tray 4 to be in as-tilted state such that a portion of the ice-making tray 4, on the right side in the figure, is in a downward position, as shown in FIG. 10B. Subsequently, the motor 6 is activated to thereby cause the ice-making tray 4 to be in as-tilted state such that a portion of the ice-making tray 4, on the left side in the figure, is in a downward position, as shown in FIG. 10C. Then, the motor 6 is activated to thereby cause the ice-making tray 4 to be in the horizontal state, as shown in FIG. 10D. In this state, an intersecting line between the center face E of the ice-making tray 4, and an extension face of water surfaces of the water 20 coincides with a rotation center line of the ice-making tray 4. Subsequently, as with the case of the automatic icemaker shown in FIGS. 1 to 3, the water 20 inside the small chambers 30, 32 is frozen, respectively, to be thereby turned into respective ice pieces 22 before discharging the respective ice pieces 22 inside the small chambers 30, 32 into an ice-piece-storage box.

With this automatic icemaker described, when the water 20 is fed from the two water inlets into the small chambers 30, 32, respectively, with the ice-making tray 4 kept in the horizontal state, the water 20 flows into the respective small chambers 30, 32, adjacent to each other, through the water channels 38, 40 respectively, however, the water 20 does not sufficiently flows into the respective small chambers 30, 32, away from the respective water inlets. Then, in a state shown in FIG. 10B, the water 20 in the respective small chambers 32 can flow through the water channel 40, so that it is possible to evenly distribute poured water into the respective small chambers 32. Further, in a state shown in FIG. 10C, the water 20 in the respective small chambers 30 can flow through the water channel 38, so that it is possible to evenly distribute poured water into the respective small chambers 30. Furthermore, in a state shown in FIG. 10D, respective water surfaces of the water 20 in the small chambers 30, 32, respectively, are positioned lower than the respective bottom faces of the water channels 38, 40, so that no water remains in the water channels 38, 40, and consequently, the respective ice pieces 22 in the adjacent small chambers 30, 32 are not joined together through the intermediary of ice pieces formed in the water channels 38, 40, respectively. Further, since the small chambers 30, 32 of the ice-making tray 4 are not disposed in a stepwise manner, a makeup of the icemaker does not increase in size, and since there is no need for sequentially feeding water to the respective small chambers 30, 32, water-feed time does not become longer.

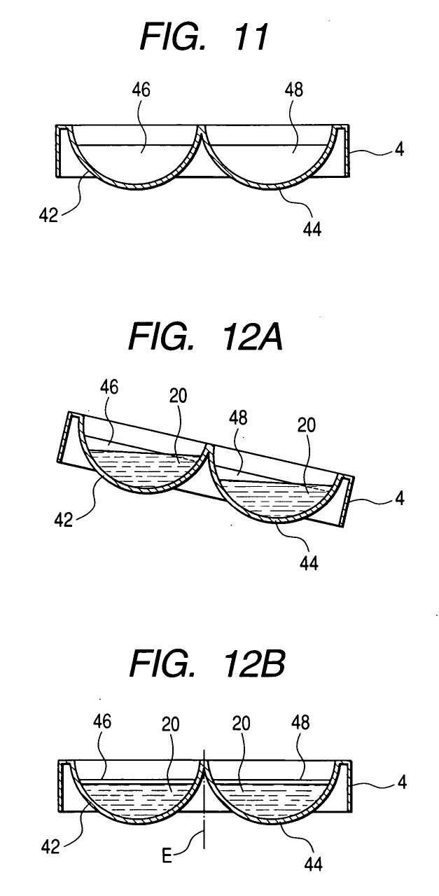

A still further embodiment of an automatic icemaker according to the invention is described hereinafter with reference to FIG. 11. An ice-making tray 4 is provided with a plurality of small chambers 42, 44, arranged in two lines, and the plurality of the small chambers 42, 44, in the respective lines, are arranged in the direction of a rotation center line of the ice-making tray 4. Partition walls 46, 48 are provided between the small chambers 42, 44, adjacent to each other in the respective lines, respectively, and respective upper surfaces of the partition walls 46, 48 are positioned below an upper surface of the ice-making tray 4.

A method of making ice pieces by use of this automatic icemaker described is described hereinafter. First, a motor 6 is activated to thereby cause the ice-making tray 4 to be in as-tilted state such that a portion of the ice-making tray 4, on the right side in the figure, is in a downward position, as shown in FIG. 12A, and in that state, water 20 is fed from two water inlets into the small chambers 42, 44, respectively. Next, the motor 6 is activated to thereby cause the ice-making tray 4 to be in the horizontal state, as shown in FIG. 12B. In this state, an intersecting line between the center face E of the ice-making tray 4, and an extension face of water surfaces of the water 20 coincides with a rotation center line of the ice-making tray 4. Subsequently, as with the case of the automatic icemaker shown in FIGS. 1 to 3, the water 20 inside the respective small chambers 42, 44 is frozen to be thereby turned into respective ice pieces 22 before discharging the respective ice pieces 22 inside the small chambers 42, 44 into an ice-piece-storage box.

With this automatic icemaker in a state shown in FIG. 12A, the water 20 in the respective small chambers 42, 44 can flow over portions of the respective upper surfaces of the partition walls 46, 48, on the right side in the figure, so that it is possible to evenly distribute poured water into the respective small chambers 42, 44. Further, in a state shown in FIG. 12B, the water surfaces of the water 20 in the respective small chambers 42, 44 are positioned below the respective upper surfaces of the partition walls 46, 48, so that the respective ice pieces 22 in the small chambers 42, 44, adjacent to each other in the respective lines, are not joined together. Further, since the small chambers 42, 44 of the ice-making tray 4 are not disposed in a stepwise manner, a makeup of the icemaker does not increase in size, and since there is no need for sequentially feeding water to the respective small chambers 42, 44, water-feed time does not become longer.

Further, a control circuit (not shown) for the motor 6 and a control circuit (not shown) for a solenoid controlled valve of the water inlet 12 are installed inside the main body 2. Still further, with the respective automatic icemakers described hereinbefore, the water channel 18, or 24, in a groove shape, is provided at the respective end portions of the partition walls 16 each being provided between the small chambers 14 adjacent to each other, and the water channels 38, 40 are provided at the respective end portions of the partition walls 34, 36, provided between the respective small chambers 30, 32, adjacent to each other in the respective lines, respectively, however, the invention is not limited to such a configuration, and a water channel (or water channels), in a groove shape, may be provided at off-center portions of the partition walls provided between the respective small chambers adjacent to each other.

What is claimed is:

1. An automatic icemaker comprising:
a main body;
an ice-making tray rotatably fitted to the main body; and
a device for rotating the ice-making tray,
wherein the ice-making tray is provided with a plurality of small chambers, the plurality of the small chambers are arranged in the direction of a rotation center line of the ice-making tray, and a water channel in a groove shape is provided at respective off-center portions of partition walls, each being provided between the respective small chambers adjacent to each other.

2. An automatic icemaker according to claim 1, wherein the wall of the water channel, on one side thereof, is in common with the wall of the ice-making tray.

3. An automatic icemaker according to claim 1, wherein a size of an upper part of the small chamber, in the direction of the rotation center line of the ice-making tray, is smaller than a size thereof, in the direction orthogonal to the direction of the rotation center line of the ice-making tray.

4. An automatic icemaker according to claim 1, wherein the plurality of the small chambers are arranged in two lines.

5. An automatic icemaker comprising:
a main body;
an ice-making tray rotatably fitted to the main body; and
a device for rotating the ice-making tray,
wherein the ice-making tray is provided with a plurality of small chambers, the plurality of the small chambers are arranged in the direction of a rotation center line of the ice-making tray, and an upper surface of a partition wall provided between the respective small chambers adjacent to each other is positioned below an upper surface of the ice-making tray.

6. An automatic icemaker according to claim 5, wherein a size of an upper part of the small chamber, in the direction of the rotation center line of the ice-making tray, is smaller than a size thereof, in the direction orthogonal to the direction of the rotation center line of the ice-making tray.

7. An automatic icemaker according to claim 5, wherein the plurality of the small chambers are arranged in two lines.
